(19) United States
(12) Patent Application Publication
(10) Pub. No.: US 2025/0193913 A1
(43) Pub. Date: Jun. 12, 2025

(54) RESOURCE ALLOCATION METHOD AND APPARATUS, INFORMATION REPORTING METHOD AND APPARATUS, TERMINAL DEVICE, AND NETWORK SIDE DEVICE

(71) Applicant: VIVO MOBILE COMMUNICATION CO., LTD., Dongguan (CN)

(72) Inventors: Xueming PAN, Dongguan (CN); Zuolong YING, Dongguan (CN); Kai WU, Dongguan (CN); Jiansheng CAI, Dongguan (CN)

(21) Appl. No.: 19/059,314

(22) Filed: Feb. 21, 2025

Related U.S. Application Data
(63) Continuation of application No. PCT/CN2023/113281, filed on Aug. 16, 2023.

(30) Foreign Application Priority Data
Aug. 22, 2022 (CN) 202211008791.3

(51) Int. Cl. H04W 72/51; H04W 72/53

(52) U.S. Cl. CPC H04W 72/51; H04W 72/53

(57) ABSTRACT

This application discloses a resource allocation method which includes: The network side device sends first information to a target device, where the target device includes at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device.

### CROSS-REFERENCE TO RELATED APPLICATIONS

This application is a continuation of International Patent Application No. PCT/CN2023/113281, filed on Aug. 16, 2023, which claims priority to Chinese Patent Application No. 202211008791.3, filed with the China National Intellectual Property Administration on Aug. 22, 2022, and entitled “RESOURCE ALLOCATION METHOD AND APPARATUS, INFORMATION REPORTING METHOD AND APPARATUS, TERMINAL DEVICE, AND NETWORK SIDE DEVICE”, which is incorporated herein by reference in its entirety.

### TECHNICAL FIELD

This application relates to the field of communications technologies, and specifically, to a resource allocation method and apparatus, an information reporting method and apparatus, a terminal device, and a network side device.

### BACKGROUND

In passive internet of things (Passive IoT, PIOT) or ultra-low power consumption communication scenarios, a reader (such as a network side device) usually obtains related information (such as status information) of a tag in an inventory manner.

However, in a case of a large quantity of tags, a method for obtaining the related information of the tag in the inventory manner is inefficient and needs to be improved.

### SUMMARY

According to a first aspect, a resource allocation method is provided. The method includes:

A network side device sends first information to a target device, where
the target device includes at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device; and
the preset rule includes at least one of the following:
   selecting different resources for different reporting service types;
   selecting different resources for different types of target devices;
   selecting a same resource for multiple target devices;
   selecting a specified resource for a specified target device; and
   selecting different resources in frequency domain at different moments for a specified target device.

According to a second aspect, an information reporting method is provided. The method includes:

A target device receives first information from a network side device, where the target device includes one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule; and
the target device reports second information to the network side device based on the target resource, where
the preset rule includes at least one of the following:
   selecting different resources for different reporting service types;
   selecting different resources for different types of target devices;
   selecting a same resource for multiple target devices;
   selecting a specified resource for a specified target device; and
   selecting different resources in frequency domain at different moments for a specified target device.

According to a third aspect, a resource allocation apparatus is provided. The apparatus includes:
a resource allocation module, configured to send first information to a target device, where
the target device includes at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device; and
the preset rule includes at least one of the following:
   selecting different resources for different reporting service types;
   selecting different resources for different types of target devices;
   selecting a same resource for multiple target devices;
   selecting a specified resource for a specified target device; and
   selecting different resources in frequency domain at different moments for a specified target device.

According to a fourth aspect, an information reporting apparatus is provided. The apparatus includes:
an information receiving module, configured to receive first information from a network side device, where the first information is used to allocate a target resource to a target device, the target resource is selected by the network side device from a preset resource set according to a preset rule, or the first information is used to configure the preset resource set for the target device, so that the target device selects the target resource from the preset resource set according to the preset rule, the target device includes one of a backscatter communication device and an ultra-low power device, and the ultra-low power device is a terminal device whose power consumption is less than a preset threshold; and
an information reporting module, configured to report second information to the network side device based on the resource, where
the preset rule includes at least one of the following:
   selecting different resources for different reporting service types;
   selecting different resources for different types of target devices;
   selecting a same resource for multiple target devices;
   selecting a specified resource for a specified target device; and
   selecting different resources in frequency domain at different moments for a specified target device.

According to a fifth aspect, a communication system is provided. The communication system includes a network side device and a target device.

The network side device is configured to send first information to the target device, where the target device includes at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule.

The target device is configured to receive the first information from the network side device, and report second information to the network side device based on the target resource, where
the preset rule includes at least one of the following:
   selecting different resources for different reporting service types;
   selecting different resources for different types of target devices;
   selecting a same resource for multiple target devices;
   selecting a specified resource for a specified target device; and
   selecting different resources in frequency domain at different moments for a specified target device.

According to a sixth aspect, a network side device is provided. The network side device includes a processor and a memory, the memory stores a program or an instruction that is executable on the processor, and when the program or the instruction is executed by the processor, the steps of the resource allocation method according to the first aspect are implemented.

According to a seventh aspect, a reader is provided. The reader includes a processor and a memory, the memory stores a program or an instruction that is executable on the processor, and when the program or the instruction is executed by the processor, the steps of the resource allocation method according to the first aspect are implemented.

According to an eighth aspect, a terminal device is provided. The terminal device includes a processor and a memory, the memory stores a program or an instruction that is executable on the processor, and when the program or the instruction is executed by the processor, the steps of the information reporting method according to the second aspect are implemented.

According to a ninth aspect, a tag is provided. The tag includes a processor and a memory, the memory stores a program or an instruction that is executable on the processor, and when the program or the instruction is executed by the processor, the steps of the information reporting method according to the second aspect are implemented.

According to a tenth aspect, a network side device is provided, and includes a communication interface. The communication interface is configured to send first information to a target device, where
the target device includes at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device; and
the preset rule includes at least one of the following:
   selecting different resources for different reporting service types;
   selecting different resources for different types of target devices;
   selecting a same resource for multiple target devices;
   selecting a specified resource for a specified target device; and
   selecting different resources in frequency domain at different moments for a specified target device.

According to an eleventh aspect, a reader is provided, and includes a communication interface. The communication interface is configured to send first information to a target device, where
the target device includes at least one of a backscatter communication device and an ultra-low power device, the ultra-low power device is a terminal device whose power consumption is less than a preset threshold, the first information is used to allocate a target resource to the target device, the target resource is selected by the reader from a preset resource set according to a preset rule, or the first information is used to configure the preset resource set for the target device, so that the target device selects the target resource from the preset resource set according to the preset rule, and the target resource is used by the target device to report second information to the reader; and
the preset rule includes at least one of the following:
   selecting different resources for different reporting service types;
   selecting different resources for different types of target devices;
   selecting a same resource for multiple target devices;
   selecting a specified resource for a specified target device; and
   selecting different resources in frequency domain at different moments for a specified target device.

According to a twelfth aspect, a terminal device is provided, and includes a communication interface. The communication interface is configured to receive first information from a network side device, and report second information to the network side device based on a target resource, where
the first information is used to allocate the target resource to the terminal device, the target resource is selected by the network side device from a preset resource set according to a preset rule, or the first information is used to configure the preset resource set for the terminal device, so that the terminal device selects the target resource from the preset resource set according to the preset rule; and
the preset rule includes at least one of the following:
   selecting different resources for different reporting service types;
   selecting different resources for different types of target devices;
   selecting a same resource for multiple target devices;
   selecting a specified resource for a specified target device; and
   selecting different resources in frequency domain at different moments for a specified target device.

According to a thirteenth aspect, a tag is provided, and includes a communication interface. The communication interface is configured to receive first information from a network side device, and report second information to the network side device based on a target resource, where
the first information is used to allocate the target resource to the tag, the target resource is selected by the network side device from a preset resource set according to a preset rule, or the first information is used to configure the preset resource set for the tag, so that the tag selects the target resource from the preset resource set according to the preset rule; and
the preset rule includes at least one of the following:
   selecting different resources for different reporting service types;
   selecting different resources for different types of target devices;
   selecting a same resource for multiple target devices;
   selecting a specified resource for a specified target device; and
   selecting different resources in frequency domain at different moments for a specified target device.

According to a fourteenth aspect, a communication system is provided, including a network side device and a target device. The network side device is configured to perform the steps of the resource allocation method according to the first aspect, and the target device is configured to perform the steps of the information reporting method according to the second aspect.

According to a fifteenth aspect, a readable storage medium is provided. The readable storage medium stores a program or an instruction, and when the program or the instruction is executed by a processor, the steps of the method according to the first aspect or the second aspect are implemented.

According to a sixteenth aspect, a chip is provided. The chip includes a processor and a communication interface. The communication interface is coupled to the processor. The processor is configured to run a program or an instruction, to implement the steps of the method according to the first aspect or the second aspect.

According to a seventeenth aspect, a computer program/program product is provided. The computer program/program product is stored in a storage medium, and the computer program/program product is executed by at least one processor to implement the steps of the method according to the first aspect or the second aspect.

### BRIEF DESCRIPTION OF DRAWINGS

FIG. 1 is a block diagram of a wireless communication system according to an embodiment of this application;

FIG. 2 is a block diagram of a PIOT wireless communication system according to an embodiment of this application;

FIG. 3 is a schematic flowchart of a resource allocation method according to an embodiment of this application;

FIG. 4 is a first schematic diagram of an implementation effect of a resource allocation method according to an embodiment of this application;

FIG. 5 is a second schematic diagram of an implementation effect of a resource allocation method according to an embodiment of this application;

FIG. 6 is a third schematic diagram of an implementation effect of a resource allocation method according to an embodiment of this application;

FIG. 7 is a fourth schematic diagram of an allocation effect of a resource allocation method according to an embodiment of this application;

FIG. 8 is a fifth schematic diagram of an allocation effect of a resource allocation method according to an embodiment of this application;

FIG. 9 is a schematic flowchart of an information reporting method according to an embodiment of this application;

FIG. 10 is a schematic diagram of a structure of a resource allocation apparatus according to an embodiment of this application;

FIG. 11 is a schematic diagram of a structure of an information reporting apparatus according to an embodiment of this application;

FIG. 12 is a schematic diagram of a structure of a communication device according to this application;

FIG. 13 is a schematic diagram of a hardware structure of a terminal device according to an embodiment of this application; and

FIG. 14 is a schematic diagram of a hardware structure of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the specification and the claims, “and/or” represents at least one of connected objects, and a character “/” generally represents an “or” relationship between associated objects.

It should be noted that technologies described in the embodiments of this application are not limited to a Long Term Evolution (Long Term Evolution, LTE)/LTE-Advanced (LTE-Advanced, LTE-A) system, and may further be applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency division multiple access (Single-carrier Frequency Division Multiple Access, SC-FDMA), and other systems. The terms “system” and “network” in the embodiments of this application may be used interchangeably. The technologies described can be applied to both the systems and the radio technologies mentioned above as well as to other systems and radio technologies. A new radio (New Radio, NR) system is described in the following description for illustrative purposes, and the NR terminology is used in most of the following description, although these technologies can also be applied to applications other than the NR system application, such as the 6^{th} generation (6^{th} Generation, 6G) communication system.

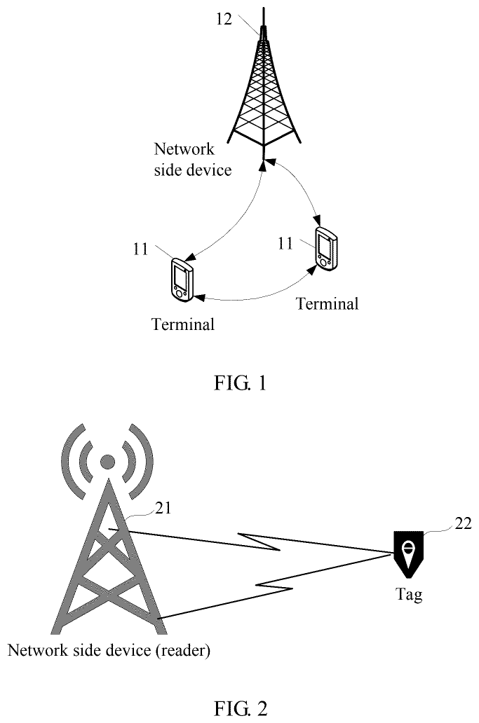

FIG. 1 is a block diagram of a wireless communication system to which embodiments of this application may be applied. The wireless communication system includes a terminal 11 and a network side device 12. The terminal 11 may be a terminal side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), pedestrian user equipment (Pedestrian User Equipment, PUE), a smart home (a home device with a wireless communication function, such as a refrigerator, a television, a washing machine, or a furniture), a game console, a personal computer (personal computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a radio access network (Radio Access Network, RAN), a radio access network function, or a radio access network unit. The access network device 12 may include a base station, a wireless local area network (Wireless Local Area Network, WLAN) access point, a Wi-Fi node, or the like. The base station may be referred to as a NodeB, an evolved NodeB (evolved NodeB, eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmitting Receiving Point, TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited.

To resolve a problem of low efficiency in obtaining related information of a tag or a terminal device in passive internet of things (Passive IoT, PIOT) or ultra-low power consumption communication scenarios, the embodiments of this application provide a resource allocation method and apparatus, an information reporting method and apparatus, a network side device, a terminal device, and a tag.

FIG. 2 is a block diagram of a PIOT wireless communication system to which embodiments of this application may be applied. The PIOT wireless communication system includes a network side device 21 and a tag (Tag) 22. In this application scenario, the network side device 21 serves as a reader (reader), and sends a signal such as a control command (command) or a continuous wave (continuous wave, CW) to the tag 22, where the network side device 21 may be a base station (Base station); and the tag 22 may feed back information to the network side device 21.

The tag 22 may be a backscatter communication (Backscatter Communication, BSC) device. When the tag 22 is the BSC device, the tag 22 with a backscatter communication capability may return a backscatter signal (such as a Tag reply) to the network side device 21.

A backscatter communication technology is a communication technology in which the backscatter communication device performs signal modulation by using a radio frequency signal in another device or an environment to transmit information of the backscatter communication device. The backscatter communication device may be one of the following several devices: a backscatter communication device in conventional radio frequency identification (Radio Frequency Identification, RFID) that is usually a tag and belongs to a passive IoT device (passive-IoT); a semi-passive (semi-passive) tag, where downlink receiving or uplink reflection of this type of tag has a specific amplification capability; and a tag with an active sending capability (active tag), where this type of tag may send information to a reader without relying on reflection of an incident signal.

Although FIG. 2 only shows the application scenario of communication between the independent tag and the network side device, it is not excluded that the solution provided in the embodiments of this application may be further applied to an application scenario of communication between a terminal device (User Equipment, UE)-aided tag and a network side device or to an application scenario of communication between a tag and a terminal device (User Equipment, UE).

Moreover, in addition to the communication scenario shown in FIG. 2, the embodiments of this application may be further applied to an ultra-low power consumption communication scenario, that is, may be applied to a scenario of communication between a tag or a terminal device with ultra-low power consumption and a network side device. Herein, the ultra-low power consumption means that power consumption is less than a preset threshold, for example, power consumption is less than 0 milliwatt decibels (dBm).

Embodiments of this application provide a resource allocation method and apparatus, an information reporting method and apparatus, a terminal device, and a network side device, to improve efficiency of obtaining related information of a target device.

In the embodiments of this application, because the network side device allocates, to the target device (the backscatter communication device or the ultra-low power device), the target resource that may be used to report the second information, or the target device may actively select, based on the preset resource set configured by the network side device, the target resource used to report the second information. In this way, the target device may actively and quickly report the second information based on the target resource without waiting for an inventory of the network side device. Therefore, the efficiency of obtaining the related information of the target device can be improved.

The following first describes a resource allocation method provided in embodiments of this application.

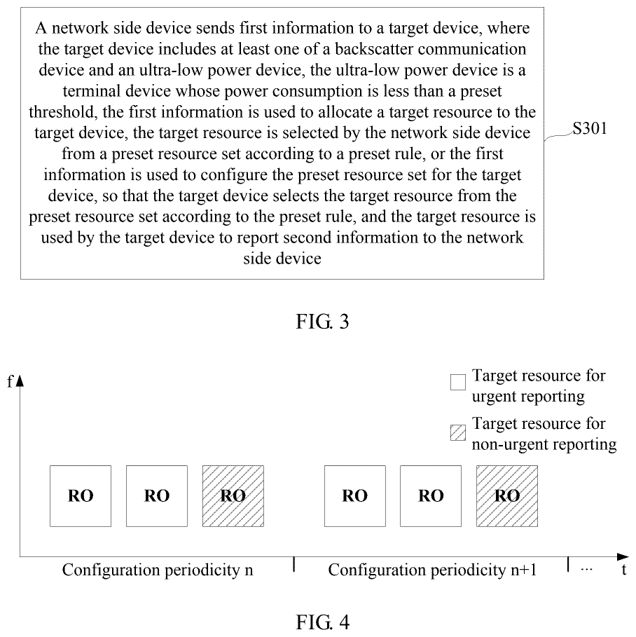

As shown in FIG. 3, a resource allocation method provided in an embodiment of this application may include the following step:

Step 301: A network side device sends first information to a target device, where the target device includes at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device.

In this embodiment of this application, the target device is a device capable of initiating uplink reporting, and there may be one or more target devices. In an application scenario, the target device can be the BSC device, such as a tag. In another application scenario, the target device may be an ultra-low power device, that is, a terminal device with power consumption less than a preset threshold, where the preset threshold may be less than or equal to 0 dBm.

In this embodiment of this application, the first information may have one of the following functions:

In a first function, the first information is used to allocate the target resource to the target device, the target resource is selected by the network side device from the preset resource set according to the preset rule, and the preset resource set may be preconfigured by the network side device to the target device. Correspondingly, before step 301, the method shown in FIG. 3 may further include: The network side device sends configuration information to the target device, where the configuration information is used to configure the preset resource set for the target device; and the network side device selects the target resource from the preset resource set according to the preset rule. In other words, in a case that the network side device preconfigures the preset resource set for the target device, the network side device may select the target resource from the preset resource set according to the preset rule, and dynamically indicate the target resource to the target device through the first information, so that the target device reports the second information on the target resource.

In a second function, the first information is used to configure the preset resource set for the target device, so that the target device selects the target resource from the preset resource set according to the preset rule. In other words, the network side device may configure the preset resource set for the target device through the first information, and after the configuration, the target device may select, according to the preset rule, the target resource used to report the second information from the preset resource set.

The preset rule may include but is not limited to at least one of the following:
(1) selecting different resources for different reporting service types;
(2) selecting different resources for different types of target devices;
(3) selecting a same resource for multiple target devices;
(4) selecting a specified resource for a specified target device; and
(5) selecting different resources in frequency domain at different moments for a specified target device.

The preset rule may be determined in at least one of the following manners:
(1) predefined in a protocol;
(2) preconfigured by the network side device; and
(3) indicated by the network side device.

To increase resource utilization, a resource in the preset resource set may fulfill at least one of the following conditions:
time division multiplexing (Time division multiplexing, TDM);
frequency division multiplexing (Frequency Division Multiplexing, FDM); and
space division multiplexing (Space Division Multiplexing, SDM).

In this embodiment of this application, different resources are resources that are different in at least one of time domain, frequency domain, and space domain.

In this embodiment of this application, same resources are resources that are the same in at least one of time domain, frequency domain, and space domain.

The five preset rules described above are described below separately by using five embodiments.

### Embodiment 1

The preset rule includes selecting the different resources for the different reporting service types, that is, allocating different resources to different service types for uplink reporting. Different resources herein may be resources different in at least one of time domain, frequency domain, and space domain. For example, the service type for uplink reporting herein may include but is not limited to one of urgent reporting and non-urgent reporting. The urgent reporting may include reporting of urgent service information such as a fire alarm or a radiation anomaly, and the non-urgent reporting may include reporting of one or more pieces of non-urgent service information such as temperature information, motion information, vibration information, air quality, and humidity.

Through classification according to the service type, the network side device may determine, according to a quantity of target devices for different service types, to allocate at least one of a periodicity and a quantity of target resources to the target device, to increase resource utilization and reduce a resource utilization conflict probability.

In a case that the reporting service type includes urgent reporting and non-urgent reporting, the selecting the different resources for the different reporting service types may include: a quantity of target resources selected for a target device for the urgent reporting is greater than a quantity of target resources selected for a target device for the non-urgent reporting. For example, as shown in FIG. 4, one report (report) configuration periodicity may be configured with three time division multiplexed (time domain division multiplexed, TDMed) target resources. The target resource may be represented by a report occasion (report occasion, RO). Two of the three ROs may be used for the urgent (urgent) reporting, and one remaining RO may be used for the non-urgent (normal) reporting.

It may be understood that the different resources are selected for the different reporting service types, to reduce, to some extent, a conflict of resources used when target devices for different service types perform uplink reporting, and further improve resource utilization efficiency.

### Embodiment 2

The preset rule includes selecting the different resources for the different types of target devices, and a type of the target device is determined in a preset classification manner.

The preset classification manner may include but is not limited to at least one of the following:

(1) Classifying the type of the target device based on an identifier (Identifier, ID) of the target device.

In an example, the classifying the type of the target device based on an ID of the target device may include: classifying a target device with an odd ID into one type, and classifying a target device with an even ID into another type. Correspondingly, the selecting the different resources for the different types of target devices may include: selecting a first target resource for the target device with the odd ID, and selecting a second target resource for the target device with the even ID, where the first target resource is different from the second target resource.

In another example, the classifying the type of the target device based on an ID of the target device may include: classifying target devices with different IDs into different types of target devices. Correspondingly, the selecting the different resources for the different types of target devices may include: mapping resources with different IDs to target devices with different IDs, where an ID of a resource is determined based on a time domain order or a frequency domain order of the resource. The ID of the resource uniquely identifies the resource. Therefore, specifically, different resource IDs (resource ID) may be mapped to different target device IDs (such as tag IDs) to allocate different resources to different target devices.

(2) Classifying the type of the target device based on a group to which the target device belongs.

One group corresponds to one attribute, such as a data amount (a size of the second information) of the second information to be reported.

In an example, the classifying the type of the target device based on the group to which the target device belongs may include: determining, based on a data amount of the second information to be reported by the target device, the group to which the target device belongs; and classifying target devices belonging to different groups into different types. For example, target devices may be classified into a tag group A (group A) and a tag group B (group B) based on the data amount of the second information to be reported by the target device, a data amount of second information to be reported by a target device in the tag group A is less than or equal to a preset data amount, and a data amount of second information to be reported by a target device in the tag group B is greater than the preset data amount.

(3) Classifying the type of the target device based on whether the target device has power.

In an example, the classifying the type of the target device based on whether the target device has power may include:
classifying a passive target device (such as a passive tag) into a first type;
classifying a semi-passive target device (such as a semi-passive tag) into a second type; and
classifying an active target device (such as an active tag) into a third type.

The first type, the second type, and the third type mean different types.

(4) Classifying the type of the target device based on a maximum data amount that the target device is able to report.

In an example, the classifying the type of the target device based on a maximum data amount that the target device is able to report may include: classifying a target device that is able to report a maximum data amount being a small data amount into a first type; classifying a target device that is able to report a maximum data amount being a medium data amount into a second type; and classifying a target device that is able to report a maximum data amount being a large data amount into a third type.

More specifically, a target device that is able to report a maximum data amount less than a first data amount may be classified into a first type; a target device that is able to report a maximum data amount less than a second data amount and greater than or equal to the first data amount may be classified into a second type; and a target device that is able to report a maximum data amount less than a third data amount and greater than or equal to the second data amount may be classified into a third type. Alternatively, a target device that is able to report a maximum data amount less than or equal to a first data amount may be classified into a first type; a target device that is able to report a maximum data amount less than or equal to a second data amount and greater than the first data amount may be classified into a second type; and a target device that is able to report a maximum data amount less than or equal to a third data amount and greater than the second data amount may be classified into a third type.

The first type, the second type, and the third type are different types.

(5) Classifying the type of the target device based on an environment monitoring capability of the target device.

In an example, the classifying the type of the target device based on an environment monitoring capability of the target device may include: classifying target devices with different environment monitoring capabilities into different types.

The environment monitoring capability may include but is not limited to one of the following:
an environment temperature monitoring capability;
an environment humidity monitoring capability;
an environment radiation intensity monitoring capability; and
an environment smoke amount monitoring capability.

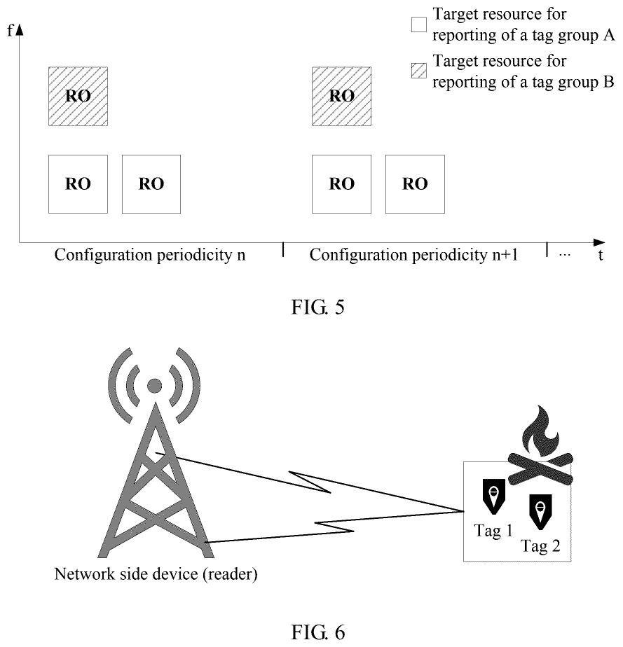

FIG. 5 shows an example of selecting different resources for different types of target devices. As shown in FIG. 5, one report (report) configuration periodicity may be configured with three target resources (RO), two of the three ROs are in a same frequency domain resource, and one remaining RO is in another frequency domain resource. The two ROs in the same frequency domain resource may be used by the target device in the tag group A (group A) to report the second information, and one RO in the another frequency domain resource may be used by the target device in the tag group B (group B) to report the second information.

It may also be understood that the different resources are selected for the different types of target devices, to reduce, to some extent, a conflict of resources used when the different types of target devices perform uplink reporting, and further improve resource utilization efficiency.

### Embodiment 3

The preset rule includes selecting the same resource for the multiple target devices. That is, in some embodiments, multiple tags are allowed to select a same resource to send an uplink report (report). Same resources herein may be resources that are the same in at least one of time domain (time), frequency domain (frequency), and space domain (space).

In an example, the selecting the same resource for the multiple target devices may include: selecting a same resource for multiple target devices of a same type. More specifically, the multiple target devices of the same type may include multiple target devices with equal or approximately equal distances from the network side device; and/or the multiple target devices of the same type may include multiple target devices whose locations are the same or close.

For example, when an uplink report does not need to be associated with a single piece of tag information and is associated only with tag type information, multiple tags of a same type may be allowed to generate a same uplink report, and use a same resource for reporting. More specifically, in this case, it may be assumed that locations of the multiple tags have approximately equal distances from a location of a receiver (network side device), to ensure actual synchronization and avoid interference between uplink reports from different tags on the same resource. As shown in FIG. 6, two tags whose locations are the same or close (co-located) may report fire alarm information on a same resource at the same time.

### Embodiment 4

The preset rule includes selecting the specified resource for the specified target device. That is, in some embodiments, the network may indicate that a specified resource is used for a purpose, tag reporting, or multi-tag reporting.

Specifically, the specified target device may include but is not limited to at least one of the following:
a target device for a specified purpose;
a target device of a specified type; and
at least one specified target device, for example, multiple specified tags that may report information at the same time.

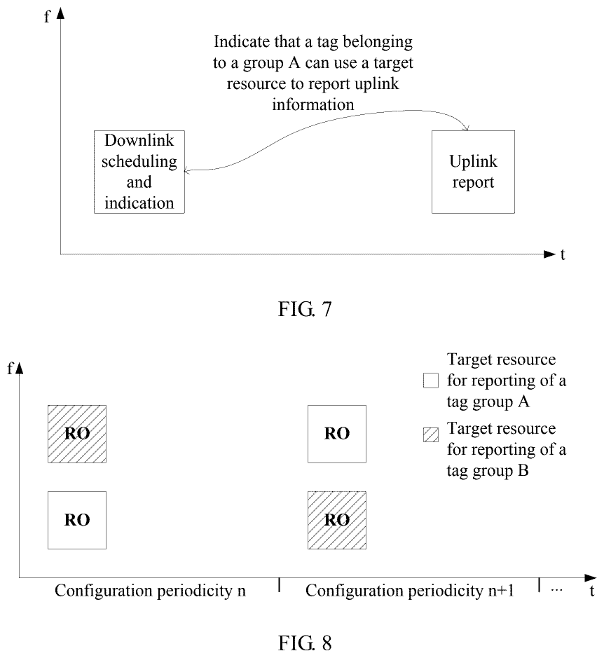

Further, when the network side device dynamically schedules a resource required for uplink reporting to multiple tags, the network side device/reader may specify, when scheduling the resource, specific types of tags or tags for specific service types (or serving types) that may use the resource to report information, or whether to allow multiple tags to perform reporting at the same time. For example, as shown in FIG. 7, when the network side device may schedule a resource that may be used by multiple tags or multiple types of tags, the network side device indicates that only a tag belonging to a tag group A (group A) may use the resource to report uplink information.

### Embodiment 5

The preset rule includes selecting the different resources in frequency domain at the different moments for the specified target device. That is, in some embodiments, a resource used for a purpose, a tag type, or multi-tag reporting may be frequency-hopped in frequency domain.

Specifically, the specified target device may include but is not limited to at least one of the following:
a target device for a specified purpose;
a target device of a specified type; and
at least one specified target device, for example, multiple specified tags that may report information at the same time.

In this case, tags of a same type do not have to use a fixed frequency domain resource to report information at different moments, and this type of tags may be allowed to change a moment to select an appropriate frequency domain resource, to improve signal receiving performance. For example, as shown in FIG. 8, a target resource (RO) allocated to a tag group A (group A) or a tag group B (group B) may be frequency-hopped with a report configuration periodicity.

In addition, it should be noted that in each embodiment of this application, the second information reported by the target device may include but is not limited to at least one of a reporting request and information to be reported. As mentioned above, for a tag that provides a fire alarm service, information to be reported may be fire alarm information, and other service types are similar. Details are not described again.

In the resource allocation method provided in the embodiments of this application, because the network side device allocates, to the target device (the backscatter communication device or the ultra-low power device), the target resource that may be used to report the second information, or the target device may actively select, based on the preset resource set configured by the network side device, the target resource used to report the second information. In this way, the target device may actively and quickly report the second information based on the target resource without waiting for an inventory of the network side device. Therefore, efficiency of obtaining related information of the target device can be improved.

The following describes an information reporting method provided in the embodiments of this application.

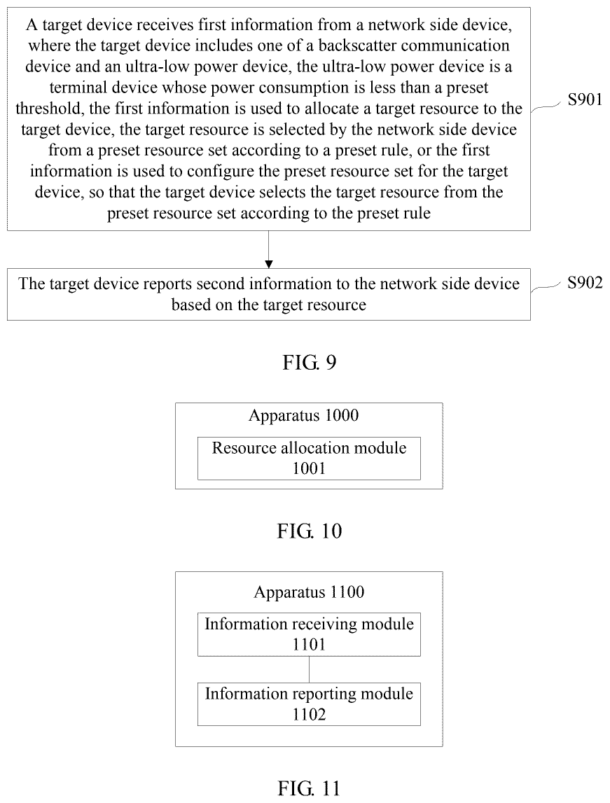

As shown in FIG. 9, an information reporting method provided in an embodiment of this application may include the following steps:

Step 901: A target device receives first information from a network side device, where the target device includes one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule.

In this embodiment of this application, the target device is a device capable of initiating uplink reporting, and there may be one or more target devices. In an application scenario, the target device can be the BSC device, such as a tag. In another application scenario, the target device may be an ultra-low power device, that is, a terminal device with power consumption less than a preset threshold, where the preset threshold may be less than or equal to 0 dBm.

In this embodiment of this application, the first information may have one of the following functions:

In a first function, the first information is used to allocate the target resource to the target device, the target resource is selected by the network side device from the preset resource set according to the preset rule, and the preset resource set may be preconfigured by the network side device to the target device. Correspondingly, before step 901, the method may further include: The target device receives configuration information from the network side device, where the configuration information is used to configure the preset resource set for the target device. In other words, in a case that the network side device preconfigures the preset resource set for the target device, the network side device may select the target resource from the preset resource set according to the preset rule, and dynamically indicate the target resource to the target device through the first information, so that the target device reports the second information on the target resource.

In a second function, the first information is used to configure the preset resource set for the target device, so that the target device selects the target resource from the preset resource set according to the preset rule. In other words, the network side device may configure the preset resource set for the target device through the first information, and after the configuration, the target device may select, according to the preset resource, the target resource used to report the second information from the preset resource set.

The preset rule may include but is not limited to at least one of the following:
(1) selecting different resources for different reporting service types;
(2) selecting different resources for different types of target devices;
(3) selecting a same resource for multiple target devices;
(4) selecting a specified resource for a specified target device; and
(5) selecting different resources in frequency domain at different moments for a specified target device.

The preset rule may be determined in at least one of the following manners:
(1) predefined in a protocol;
(2) preconfigured by the network side device; and
(3) indicated by the network side device.

To increase resource utilization, a resource in the preset resource set may fulfill at least one of the following conditions:
time division multiplexing (Time division multiplexing, TDM);
frequency division multiplexing (Frequency Division Multiplexing, FDM); and
space division multiplexing (Space Division Multiplexing, SDM).

In this embodiment of this application, different resources are resources that are different in at least one of time domain, frequency domain, and space domain.

In this embodiment of this application, same resources are resources that are the same in at least one of time domain, frequency domain, and space domain.

The five preset rules described above are described below separately by using five embodiments.

### Embodiment 1

The preset rule includes selecting the different resources for the different reporting service types, that is, allocating different resources to different service types for uplink reporting. Different resources herein may be resources different in at least one of time domain, frequency domain, and space domain. For example, the service type for uplink reporting herein may include but is not limited to one of urgent reporting and non-urgent reporting. The urgent reporting may include reporting of urgent service information such as a fire alarm or a radiation anomaly, and the non-urgent reporting may include reporting of one or more pieces of non-urgent service information such as temperature information, motion information, vibration information, air quality, and humidity.

Through classification according to the service type, the network side device may determine, according to a quantity of target devices for different service types, to allocate at least one of a periodicity and a quantity of target resources to the target device, to increase resource utilization and reduce a resource utilization conflict probability.

In a case that the reporting service type includes urgent reporting and non-urgent reporting, the selecting the different resources for the different reporting service types may include: a quantity of target resources selected for a target device for the urgent reporting is greater than a quantity of target resources selected for a target device for the non-urgent reporting. For example, as shown in FIG. 4, one report (report) configuration periodicity may be configured with three time division multiplexed (time division multiplexed, TDMed) target resources. The target resource may be represented by a report occasion (report occasion, RO). Two of the three ROs may be used for the urgent (urgent) reporting, and one remaining RO may be used for the non-urgent (normal) reporting.

It may be understood that the different resources are selected for the different reporting service types, to reduce, to some extent, a conflict of resources used when target devices for different service types perform uplink reporting, and further improve resource utilization efficiency.

### Embodiment 2

The preset rule includes selecting the different resources for the different types of target devices, and a type of the target device is determined in a preset classification manner.

The preset classification manner may include but is not limited to at least one of the following:

(1) Classifying the type of the target device based on an ID of the target device.

In an example, the classifying the type of the target device based on an ID of the target device may include: classifying a target device with an odd ID into one type, and classifying a target device with an even ID into another type. Correspondingly, the selecting the different resources for the different types of target devices may include: selecting a first target resource for the target device with the odd ID, and selecting a second target resource for the target device with the even ID, where the first target resource is different from the second target resource.

In another example, the classifying the type of the target device based on an ID of the target device may include: classifying target devices with different IDs into different types of target devices. Correspondingly, the selecting the different resources for the different types of target devices may include: mapping resources with different IDs to target devices with different IDs, where an ID of a resource is determined based on a time domain order or a frequency domain order of the resource. The ID of the resource uniquely identifies the resource. Therefore, specifically, different resource IDs (resource ID) may be mapped to different target device IDs (such as tag IDs) to allocate different resources to different target devices.

(2) Classifying the type of the target device based on a group to which the target device belongs.

One group corresponds to one attribute, such as a data amount (a size of the second information) of the second information to be reported.

In an example, the classifying the type of the target device based on the group to which the target device belongs may include: determining, based on a data amount of the second information to be reported by the target device, the group to which the target device belongs; and classifying target devices belonging to different groups into different types. For example, target devices may be classified into a tag group A (group A) and a tag group B (group B) based on the data amount of the second information to be reported by the target device, a data amount of second information to be reported by a target device in the tag group A is less than or equal to a preset data amount, and a data amount of second information to be reported by a target device in the tag group B is greater than the preset data amount.

(3) Classifying the type of the target device based on whether the target device has power.

In an example, the classifying the type of the target device based on whether the target device has power may include:
classifying a passive target device (such as a passive tag) into a first type;
classifying a semi-passive target device (such as a semi-passive tag) into a second type; and
classifying an active target device (such as an active tag) into a third type.

The first type, the second type, and the third type mean different types.

(4) Classifying the type of the target device based on a maximum data amount that the target device is able to report.

In an example, the classifying the type of the target device based on a maximum data amount that the target device is able to report may include: classifying a target device that is able to report a maximum data amount being a small data amount into a first type; classifying a target device that is able to report a maximum data amount being a medium data amount into a second type; and classifying a target device that is able to report a maximum data amount being a large data amount into a third type.

More specifically, a target device that is able to report a maximum data amount less than a first data amount may be classified into a first type; a target device that is able to report a maximum data amount less than a second data amount and greater than or equal to the first data amount may be classified into a second type; and a target device that is able to report a maximum data amount less than a third data amount and greater than or equal to the second data amount may be classified into a third type. Alternatively, a target device that is able to report a maximum data amount less than or equal to a first data amount may be classified into a first type; a target device that is able to report a maximum data amount less than or equal to a second data amount and greater than the first data amount may be classified into a second type; and a target device that is able to report a maximum data amount less than or equal to a third data amount and greater than the second data amount may be classified into a third type.

The first type, the second type, and the third type are different types.

(5) Classifying the type of the target device based on an environment monitoring capability of the target device.

In an example, the classifying the type of the target device based on an environment monitoring capability of the target device may include: classifying target devices with different environment monitoring capabilities into different types.

The environment monitoring capability may include but is not limited to one of the following:
an environment temperature monitoring capability;
an environment humidity monitoring capability;
an environment radiation intensity monitoring capability; and
an environment smoke amount monitoring capability.

FIG. 5 shows an example of selecting different resources for different types of target devices. As shown in FIG. 5, one report (report) configuration periodicity may be configured with three target resources (RO), two of the three ROs are in a same frequency domain resource, and one remaining RO is in another frequency domain resource. The two ROs in the same frequency domain resource may be used by the target device in the tag group A (group A) to report the second information, and one RO in the another frequency domain resource may be used by the target device in the tag group B (group B) to report the second information.

It may also be understood that the different resources are selected for the different types of target devices, to reduce, to some extent, a conflict of resources used when the different types of target devices perform uplink reporting, and further improve resource utilization efficiency.

### Embodiment 3

The preset rule includes selecting the same resource for the multiple target devices. That is, in some embodiments, multiple tags are allowed to select a same resource to send an uplink report (report). Same resources herein may be resources that are the same in at least one of time domain (time), frequency domain (frequency), and space domain (space).

In an example, the selecting the same resource for the multiple target devices may include: selecting a same resource for multiple target devices of a same type. More specifically, the multiple target devices of the same type may include multiple target devices with equal or approximately equal distances from the network side device; and/or the multiple target devices of the same type may include multiple target devices whose locations are the same or close.

For example, when an uplink report does not need to be associated with a single piece of tag information and is associated only with tag type information, multiple tags of a same type may be allowed to generate a same uplink report, and use a same resource for reporting. More specifically, in this case, it may be assumed that locations of the multiple tags have approximately equal distances from a location of a receiver (network side device), to ensure actual synchronization and avoid interference between uplink reports from different tags on the same resource. As shown in FIG. 6, two tags whose locations are the same or close (co-located) may report fire alarm information on a same resource at the same time.

### Embodiment 4

The preset rule includes selecting the specified resource for the specified target device. That is, in some embodiments, the network may indicate that a specified resource is used for a purpose, tag reporting, or multi-tag reporting.

Specifically, the specified target device may include but is not limited to at least one of the following:
a target device for a specified purpose;
a target device of a specified type; and
at least one specified target device, for example, multiple specified tags that may report information at the same time.

Further, when the network side device dynamically schedules a resource required for uplink reporting to multiple tags, the network side device/reader may specify, when scheduling the resource, specific types of tags or tags for specific service types (or serving types) that may use the resource to report information, or whether to allow multiple tags to perform reporting at the same time. For example, as shown in FIG. 7, when the network side device may schedule a resource that may be used by multiple tags or multiple types of tags, the network side device indicates that only a tag belonging to a tag group A (group A) may use the resource to report uplink information.

### Embodiment 5

The preset rule includes selecting the different resources in frequency domain at the different moments for the specified target device. That is, in some embodiments, a resource used for a purpose, a tag type, or multi-tag reporting may be frequency-hopped in frequency domain.

Specifically, the specified target device may include but is not limited to at least one of the following:
a target device for a specified purpose;
a target device of a specified type; and
at least one specified target device, for example, multiple specified tags that may report information at the same time.

In this case, tags of a same type do not have to use a fixed frequency domain resource to report information at different moments, and this type of tags may be allowed to change a moment to select an appropriate frequency domain resource, to improve signal receiving performance. For example, as shown in FIG. 8, a target resource (RO) allocated to a tag group A (group A) or a tag group B (group B) may be frequency-hopped with a report configuration periodicity.

Step 902: The target device reports second information to the network side device based on the target resource.

The second information reported by the target device may include but is not limited to at least one of a reporting request and information to be reported. As mentioned above, for a tag that provides a fire alarm service, information to be reported may be fire alarm information, and other service types are similar. Details are not described again.

In the information reporting method provided in the embodiments of this application, because the network side device allocates, to the target device (the backscatter communication device or the ultra-low power device), the target resource that may be used to report the second information, or the target device may actively select, based on the preset resource set configured by the network side device, the target resource used to report the second information. In this way, the target device may actively and quickly report the second information based on the target resource without waiting for an inventory of the network side device. Therefore, efficiency of reporting related information to the network side device by the target device can be improved.

It should be noted that the resource allocation method provided in the embodiment shown in FIG. 3 may be performed by a resource allocation apparatus. In the embodiments of this application, the resource allocation apparatus provided in the embodiments of this application is described by using an example in which the resource allocation apparatus performs the resource allocation method. The information reporting method provided in the embodiment shown in FIG. 9 may be performed by an information reporting apparatus. In the embodiments of this application, the information reporting apparatus provided in the embodiments of this application is described by using an example in which the information reporting apparatus performs the information reporting method.

The following describes the resource allocation apparatus provided in the embodiments of this application with reference to the accompanying drawings. Because the resource allocation apparatus provided in the embodiments of this application corresponds to the resource allocation method provided in the embodiments of this application, the resource allocation apparatus provided in the embodiments of this application is briefly described. For detailed content, refer to the descriptions of the foregoing method embodiment part.

As shown in FIG. 10, an embodiment of this application provides a resource allocation apparatus 1000. The apparatus 1000 may include a resource allocation module 1001.

The resource allocation module 1001 is configured to send first information to a target device, where the target device includes at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device.

In this embodiment of this application, the first information may have one of the following functions:

In a first function, the first information is used to allocate the target resource to the target device, the target resource is selected by the network side device from the preset resource set according to the preset rule, and the preset resource set may be preconfigured by the network side device to the target device. Correspondingly, the apparatus shown in FIG. 10 may further include: an information sending module, configured to send configuration information to the target device, where the configuration information is used to configure the preset resource set for the target device; and the network side device selects the target resource from the preset resource set according to the preset rule. In other words, in a case that the network side device preconfigures the preset resource set for the target device, the network side device may select the target resource from the preset resource set according to the preset rule, and dynamically indicate the target resource to the target device through the first information, so that the target device reports the second information on the target resource.

In a second function, the first information is used to configure the preset resource set for the target device, so that the target device selects the target resource from the preset resource set according to the preset rule. In other words, the network side device may configure the preset resource set for the target device through the first information, and after the configuration, the target device may select, according to the preset rule, the target resource used to report the second information from the preset resource set.

The preset rule includes at least one of the following:
selecting different resources for different reporting service types;
selecting different resources for different types of target devices;
selecting a same resource for multiple target devices;
selecting a specified resource for a specified target device; and
selecting different resources in frequency domain at different moments for a specified target device.

The preset rule may include but is not limited to at least one of the following:
(1) selecting different resources for different reporting service types;
(2) selecting different resources for different types of target devices;
(3) selecting a same resource for multiple target devices;
(4) selecting a specified resource for a specified target device; and
(5) selecting different resources in frequency domain at different moments for a specified target device.

The preset rule may be determined in at least one of the following manners:
(1) predefined in a protocol;
(2) preconfigured by the network side device; and
(3) indicated by the network side device.

To increase resource utilization, a resource in the preset resource set may fulfill at least one of the following conditions:
time division multiplexing (Time division multiplexing, TDM);
frequency division multiplexing (Frequency Division Multiplexing, FDM); and
space division multiplexing (Space Division Multiplexing, SDM).

In this embodiment of this application, different resources are resources that are different in at least one of time domain, frequency domain, and space domain.

In this embodiment of this application, same resources are resources that are the same in at least one of time domain, frequency domain, and space domain.

The five preset rules described above are described below separately by using five embodiments.

### Embodiment 1

The preset rule includes selecting the different resources for the different reporting service types, that is, allocating different resources to different service types for uplink reporting. Different resources herein may be resources different in at least one of time domain, frequency domain, and space domain. For example, the service type for uplink reporting herein may include but is not limited to one of urgent reporting and non-urgent reporting. The urgent reporting may include reporting of urgent service information such as a fire alarm or a radiation anomaly, and the non-urgent reporting may include reporting of one or more pieces of non-urgent service information such as temperature information, motion information, vibration information, air quality, and humidity.

Through classification according to the service type, the network side device may determine, according to a quantity of target devices for different service types, to allocate at least one of a periodicity and a quantity of target resources to the target device, to increase resource utilization and reduce a resource utilization conflict probability.

In a case that the reporting service type includes urgent reporting and non-urgent reporting, the selecting the different resources for the different reporting service types may include: a quantity of target resources selected for a target device for the urgent reporting is greater than a quantity of target resources selected for a target device for the non-urgent reporting. For example, as shown in FIG. 4, one report (report) configuration periodicity may be configured with three time division multiplexed (time division multiplexed, TDMed) target resources. The target resource may be represented by a report occasion (report occasion, RO). Two of the three ROs may be used for the urgent (urgent) reporting, and one remaining RO may be used for the non-urgent (normal) reporting.

It may be understood that the different resources are selected for the different reporting service types, to reduce, to some extent, a conflict of resources used when target devices for different service types perform uplink reporting, and further improve resource utilization efficiency.

### Embodiment 2

The preset rule includes selecting the different resources for the different types of target devices, and a type of the target device is determined in a preset classification manner.

The preset classification manner may include but is not limited to at least one of the following:

(1) Classifying the type of the target device based on an ID of the target device.

In an example, the classifying the type of the target device based on an ID of the target device may include: classifying a target device with an odd ID into one type, and classifying a target device with an even ID into another type. Correspondingly, the selecting the different resources for the different types of target devices may include: selecting a first target resource for the target device with the odd ID, and selecting a second target resource for the target device with the even ID, where the first target resource is different from the second target resource.

In another example, the classifying the type of the target device based on an ID of the target device may include: classifying target devices with different IDs into different types of target devices. Correspondingly, the selecting the different resources for the different types of target devices may include: mapping resources with different IDs to target devices with different IDs, where an ID of a resource is determined based on a time domain order or a frequency domain order of the resource. The ID of the resource uniquely identifies the resource. Therefore, specifically, different resource IDs (resource ID) may be mapped to different target device IDs (such as tag IDs) to allocate different resources to different target devices.

(2) Classifying the type of the target device based on a group to which the target device belongs.

One group corresponds to one attribute, such as a data amount (a size of the second information) of the second information to be reported.

In an example, the classifying the type of the target device based on the group to which the target device belongs may include: determining, based on a data amount of the second information to be reported by the target device, the group to which the target device belongs; and classifying target devices belonging to different groups into different types. For example, target devices may be classified into a tag group A (group A) and a tag group B (group B) based on the data amount of the second information to be reported by the target device, a data amount of second information to be reported by a target device in the tag group A is less than or equal to a preset data amount, and a data amount of second information to be reported by a target device in the tag group B is greater than the preset data amount.

(3) Classifying the type of the target device based on whether the target device has power.

In an example, the classifying the type of the target device based on whether the target device has power may include:
classifying a passive target device (such as a passive tag) into a first type;
classifying a semi-passive target device (such as a semi-passive tag) into a second type; and
classifying an active target device (such as an active tag) into a third type.

The first type, the second type, and the third type mean different types.

(4) Classifying the type of the target device based on a maximum data amount that the target device is able to report.

In an example, the classifying the type of the target device based on a maximum data amount that the target device is able to report may include: classifying a target device that is able to report a maximum data amount being a small data amount into a first type; classifying a target device that is able to report a maximum data amount being a medium data amount into a second type; and classifying a target device that is able to report a maximum data amount being a large data amount into a third type.

More specifically, a target device that is able to report a maximum data amount less than a first data amount may be classified into a first type; a target device that is able to report a maximum data amount less than a second data amount and greater than or equal to the first data amount may be classified into a second type; and a target device that is able to report a maximum data amount less than a third data amount and greater than or equal to the second data amount may be classified into a third type. Alternatively, a target device that is able to report a maximum data amount less than or equal to a first data amount may be classified into a first type; a target device that is able to report a maximum data amount less than or equal to a second data amount and greater than the first data amount may be classified into a second type; and a target device that is able to report a maximum data amount less than or equal to a third data amount and greater than the second data amount may be classified into a third type.

The first type, the second type, and the third type are different types.

(5) Classifying the type of the target device based on an environment monitoring capability of the target device.

In an example, the classifying the type of the target device based on an environment monitoring capability of the target device may include: classifying target devices with different environment monitoring capabilities into different types.

The environment monitoring capability may include but is not limited to one of the following:
an environment temperature monitoring capability;
an environment humidity monitoring capability;
an environment radiation intensity monitoring capability; and
an environment smoke amount monitoring capability.

FIG. 5 shows an example of selecting different resources for different types of target devices. As shown in FIG. 5, one report (report) configuration periodicity may be configured with three target resources (RO), two of the three ROs are in a same frequency domain resource, and one remaining RO is in another frequency domain resource. The two ROs in the same frequency domain resource may be used by the target device in the tag group A (group A) to report the second information, and one RO in the another frequency domain resource may be used by the target device in the tag group B (group B) to report the second information.

It may also be understood that the different resources are selected for the different types of target devices, to reduce, to some extent, a conflict of resources used when the different types of target devices perform uplink reporting, and further improve resource utilization efficiency.

### Embodiment 3

The preset rule includes selecting the same resource for the multiple target devices. That is, in some embodiments, multiple tags are allowed to select a same resource to send an uplink report (report). Same resources herein may be resources that are the same in at least one of time domain (time), frequency domain (frequency), and space domain (space).

In an example, the selecting the same resource for the multiple target devices may include: selecting a same resource for multiple target devices of a same type. More specifically, the multiple target devices of the same type may include multiple target devices with equal or approximately equal distances from the network side device; and/or the multiple target devices of the same type may include multiple target devices whose locations are the same or close.

For example, when an uplink report does not need to be associated with a single piece of tag information and is associated only with tag type information, multiple tags of a same type may be allowed to generate a same uplink report, and use a same resource for reporting. More specifically, in this case, it may be assumed that locations of the multiple tags have approximately equal distances from a location of a receiver (network side device), to ensure actual synchronization and avoid interference between uplink reports from different tags on the same resource. As shown in FIG. 6, two tags whose locations are the same or close (co-located) may report fire alarm information on a same resource at the same time.

### Embodiment 4

The preset rule includes selecting the specified resource for the specified target device. That is, in some embodiments, the network may indicate that a specified resource is used for a purpose, tag reporting, or multi-tag reporting.

Specifically, the specified target device may include but is not limited to at least one of the following:
a target device for a specified purpose;
a target device of a specified type; and
at least one specified target device, for example, multiple specified tags that may report information at the same time.

Further, when the network side device dynamically schedules a resource required for uplink reporting to multiple tags, the network side device/reader may specify, when scheduling the resource, specific types of tags or tags for specific service types (or serving types) that may use the resource to report information, or whether to allow multiple tags to perform reporting at the same time. For example, as shown in FIG. 7, when the network side device may schedule a resource that may be used by multiple tags or multiple types of tags, the network side device indicates that only a tag belonging to a tag group A (group A) may use the resource to report uplink information.

### Embodiment 5

The preset rule includes selecting the different resources in frequency domain at the different moments for the specified target device. That is, in some embodiments, a resource used for a purpose, a tag type, or multi-tag reporting may be frequency-hopped in frequency domain.

Specifically, the specified target device may include but is not limited to at least one of the following:
a target device for a specified purpose;
a target device of a specified type; and
at least one specified target device, for example, multiple specified tags that may report information at the same time.

In this case, tags of a same type do not have to use a fixed frequency domain resource to report information at different moments, and this type of tags may be allowed to change a moment to select an appropriate frequency domain resource, to improve signal receiving performance. For example, as shown in FIG. 8, a target resource (RO) allocated to a tag group A (group A) or a tag group B (group B) may be frequency-hopped with a report configuration periodicity.

In addition, it should be noted that in each embodiment of this application, the second information reported by the target device may include but is not limited to at least one of a reporting request and information to be reported. As mentioned above, for a tag that provides a fire alarm service, information to be reported may be fire alarm information, and other service types are similar. Details are not described again.

According to the resource allocation apparatus provided in the embodiments of this application, because the network side device allocates, to the target device (the backscatter communication device or the ultra-low power device), the target resource that may be used to report the second information, or the target device may actively select, based on the preset resource set configured by the network side device, the target resource used to report the second information. In this way, the target device may actively and quickly report the second information based on the target resource without waiting for an inventory of the network side device. Therefore, efficiency of obtaining related information of the target device can be improved.

As shown in FIG. 11, an information reporting apparatus 1100 provided in an embodiment of this application may include:
an information receiving module 1101, configured to receive first information from a network side device, where the first information is used to allocate a target resource to a target device, the target resource is selected by the network side device from a preset resource set according to a preset rule, or the first information is used to configure the preset resource set for the target device, so that the target device selects the target resource from the preset resource set according to the preset rule, the target device includes one of a backscatter communication device and an ultra-low power device, and the ultra-low power device is a terminal device whose power consumption is less than a preset threshold.

In this embodiment of this application, the target device is a device capable of initiating uplink reporting, and there may be one or more target devices. In an application scenario, the target device can be the BSC device, such as a tag. In another application scenario, the target device may be an ultra-low power device, that is, a terminal device with power consumption less than a preset threshold, where the preset threshold may be less than or equal to 0 dBm.

In this embodiment of this application, the first information may have one of the following functions:

In a first function, the first information is used to allocate the target resource to the target device, the target resource is selected by the network side device from the preset resource set according to the preset rule, and the preset resource set may be preconfigured by the network side device to the target device. Correspondingly, the apparatus 1100 may further include a configuration information receiving module, configured to: before receiving the first information from the network side device, receive configuration information from the network side device, where the configuration information is used to configure the preset resource set for the target device. In other words, in a case that the network side device preconfigures the preset resource set for the target device, the network side device may select the target resource from the preset resource set according to the preset rule, and dynamically indicate the target resource to the target device through the first information, so that the target device reports the second information on the target resource.

In a second function, the first information is used to configure the preset resource set for the target device, so that the target device selects the target resource from the preset resource set according to the preset rule. In other words, the network side device may configure the preset resource set for the target device through the first information, and after the configuration, the target device may select, according to the preset rule, the target resource used to report the second information from the preset resource set.

The preset rule may include but is not limited to at least one of the following:
(1) selecting different resources for different reporting service types;
(2) selecting different resources for different types of target devices;
(3) selecting a same resource for multiple target devices;
(4) selecting a specified resource for a specified target device; and
(5) selecting different resources in frequency domain at different moments for a specified target device.

The preset rule may be determined in at least one of the following manners:
(1) predefined in a protocol;
(2) preconfigured by the network side device; and
(3) indicated by the network side device.

To increase resource utilization, a resource in the preset resource set may fulfill at least one of the following conditions:
time division multiplexing (Time division multiplexing, TDM);
frequency division multiplexing (Frequency Division Multiplexing, FDM); and
space division multiplexing (Space Division Multiplexing, SDM).

In this embodiment of this application, different resources are resources that are different in at least one of time domain, frequency domain, and space domain.

In this embodiment of this application, same resources are resources that are the same in at least one of time domain, frequency domain, and space domain.

The five preset rules described above are described below separately by using five embodiments.

### Embodiment 1

The preset rule includes selecting the different resources for the different reporting service types, that is, allocating different resources to different service types for uplink reporting. Different resources herein may be resources different in at least one of time domain, frequency domain, and space domain. For example, the service type for uplink reporting herein may include but is not limited to one of urgent reporting and non-urgent reporting. The urgent reporting may include reporting of urgent service information such as a fire alarm or a radiation anomaly, and the non-urgent reporting may include reporting of one or more pieces of non-urgent service information such as temperature information, motion information, vibration information, air quality, and humidity.

Through classification according to the service type, the network side device may determine, according to a quantity of target devices for different service types, to allocate at least one of a periodicity and a quantity of target resources to the target device, to increase resource utilization and reduce a resource utilization conflict probability.

In a case that the reporting service type includes urgent reporting and non-urgent reporting, the selecting the different resources for the different reporting service types may include: a quantity of target resources selected for a target device for the urgent reporting is greater than a quantity of target resources selected for a target device for the non-urgent reporting. For example, as shown in FIG. 4, one report (report) configuration periodicity may be configured with three time division multiplexed (time division multiplexed, TDMed) target resources. The target resource may be represented by a report occasion (report occasion, RO). Two of the three ROs may be used for the urgent (urgent) reporting, and one remaining RO may be used for the non-urgent (normal) reporting.

It may be understood that the different resources are selected for the different reporting service types, to reduce, to some extent, a conflict of resources used when target devices for different service types perform uplink reporting, and further improve resource utilization efficiency.

### Embodiment 2

The preset rule includes selecting the different resources for the different types of target devices, and a type of the target device is determined in a preset classification manner.

The preset classification manner may include but is not limited to at least one of the following:

(1) Classifying the type of the target device based on an ID of the target device.

In an example, the classifying the type of the target device based on an ID of the target device may include: classifying a target device with an odd ID into one type, and classifying a target device with an even ID into another type. Correspondingly, the selecting the different resources for the different types of target devices may include: selecting a first target resource for the target device with the odd ID, and selecting a second target resource for the target device with the even ID, where the first target resource is different from the second target resource.

In another example, the classifying the type of the target device based on an ID of the target device may include: classifying target devices with different IDs into different types of target devices. Correspondingly, the selecting the different resources for the different types of target devices may include: mapping resources with different IDs to target devices with different IDs, where an ID of a resource is determined based on a time domain order or a frequency domain order of the resource. The ID of the resource uniquely identifies the resource. Therefore, specifically, different resource IDs (resource ID) may be mapped to different target device IDs (such as tag IDs) to allocate different resources to different target devices.

(2) Classifying the type of the target device based on a group to which the target device belongs.

One group corresponds to one attribute, such as a data amount (a size of the second information) of the second information to be reported.

In an example, the classifying the type of the target device based on the group to which the target device belongs may include: determining, based on a data amount of the second information to be reported by the target device, the group to which the target device belongs; and classifying target devices belonging to different groups into different types. For example, target devices may be classified into a tag group A (group A) and a tag group B (group B) based on the data amount of the second information to be reported by the target device, a data amount of second information to be reported by a target device in the tag group A is less than or equal to a preset data amount, and a data amount of second information to be reported by a target device in the tag group B is greater than the preset data amount.

(3) Classifying the type of the target device based on whether the target device has power.

In an example, the classifying the type of the target device based on whether the target device has power may include:
classifying a passive target device (such as a passive tag) into a first type;
classifying a semi-passive target device (such as a semi-passive tag) into a second type; and
classifying an active target device (such as an active tag) into a third type.

The first type, the second type, and the third type mean different types.

(4) Classifying the type of the target device based on a maximum data amount that the target device is able to report.

In an example, the classifying the type of the target device based on a maximum data amount that the target device is able to report may include: classifying a target device that is able to report a maximum data amount being a small data amount into a first type; classifying a target device that is able to report a maximum data amount being a medium data amount into a second type; and classifying a target device that is able to report a maximum data amount being a large data amount into a third type.

More specifically, a target device that is able to report a maximum data amount less than a first data amount may be classified into a first type; a target device that is able to report a maximum data amount less than a second data amount and greater than or equal to the first data amount may be classified into a second type; and a target device that is able to report a maximum data amount less than a third data amount and greater than or equal to the second data amount may be classified into a third type. Alternatively, a target device that is able to report a maximum data amount less than or equal to a first data amount may be classified into a first type; a target device that is able to report a maximum data amount less than or equal to a second data amount and greater than the first data amount may be classified into a second type; and a target device that is able to report a maximum data amount less than or equal to a third data amount and greater than the second data amount may be classified into a third type.

The first type, the second type, and the third type are different types.

(5) Classifying the type of the target device based on an environment monitoring capability of the target device.

In an example, the classifying the type of the target device based on an environment monitoring capability of the target device may include: classifying target devices with different environment monitoring capabilities into different types.

The environment monitoring capability may include but is not limited to one of the following:
an environment temperature monitoring capability;
an environment humidity monitoring capability;
an environment radiation intensity monitoring capability; and
an environment smoke amount monitoring capability.

FIG. 5 shows an example of selecting different resources for different types of target devices. As shown in FIG. 5, one report (report) configuration periodicity may be configured with three target resources (RO), two of the three ROs are in a same frequency domain resource, and one remaining RO is in another frequency domain resource. The two ROs in the same frequency domain resource may be used by the target device in the tag group A (group A) to report the second information, and one RO in the another frequency domain resource may be used by the target device in the tag group B (group B) to report the second information.

It may also be understood that the different resources are selected for the different types of target devices, to reduce, to some extent, a conflict of resources used when the different types of target devices perform uplink reporting, and further improve resource utilization efficiency.

### Embodiment 3

The preset rule includes selecting the same resource for the multiple target devices. That is, in some embodiments, multiple tags are allowed to select a same resource to send an uplink report (report). Same resources herein may be resources that are the same in at least one of time domain (time), frequency domain (frequency), and space domain (space).

In an example, the selecting the same resource for the multiple target devices may include: selecting a same resource for multiple target devices of a same type. More specifically, the multiple target devices of the same type may include multiple target devices with equal or approximately equal distances from the network side device; and/or the multiple target devices of the same type may include multiple target devices whose locations are the same or close.

For example, when an uplink report does not need to be associated with a single piece of tag information and is associated only with tag type information, multiple tags of a same type may be allowed to generate a same uplink report, and use a same resource for reporting. More specifically, in this case, it may be assumed that locations of the multiple tags have approximately equal distances from a location of a receiver (network side device), to ensure actual synchronization and avoid interference between uplink reports from different tags on the same resource. As shown in FIG. 6, two tags whose locations are the same or close (co-located) may report fire alarm information on a same resource at the same time.

### Embodiment 4

The preset rule includes selecting the specified resource for the specified target device. That is, in some embodiments, the network may indicate that a specified resource is used for a purpose, tag reporting, or multi-tag reporting.

Specifically, the specified target device may include but is not limited to at least one of the following:
a target device for a specified purpose;
a target device of a specified type; and
at least one specified target device, for example, multiple specified tags that may report information at the same time.

Further, when the network side device dynamically schedules a resource required for uplink reporting to multiple tags, the network side device/reader may specify, when scheduling the resource, specific types of tags or tags for specific service types (or serving types) that may use the resource to report information, or whether to allow multiple tags to perform reporting at the same time. For example, as shown in FIG. 7, when the network side device may schedule a resource that may be used by multiple tags or multiple types of tags, the network side device indicates that only a tag belonging to a tag group A (group A) may use the resource to report uplink information.

### Embodiment 5

The preset rule includes selecting the different resources in frequency domain at the different moments for the specified target device. That is, in some embodiments, a resource used for a purpose, a tag type, or multi-tag reporting may be frequency-hopped in frequency domain.

Specifically, the specified target device may include but is not limited to at least one of the following:
a target device for a specified purpose;
a target device of a specified type; and
at least one specified target device, for example, multiple specified tags that may report information at the same time.

In this case, tags of a same type do not have to use a fixed frequency domain resource to report information at different moments, and this type of tags may be allowed to change a moment to select an appropriate frequency domain resource, to improve signal receiving performance. For example, as shown in FIG. 8, a target resource (RO) allocated to a tag group A (group A) or a tag group B (group B) may be frequency-hopped with a report configuration periodicity.

An information reporting module 1102 is configured to report second information to the network side device based on the target resource.

The second information may include but is not limited to at least one of a reporting request and information to be reported. As mentioned above, for a tag that provides a fire alarm service, information to be reported may be fire alarm information, and other service types are similar. Details are not described again.

According to the information reporting apparatus provided in the embodiments of this application, because the network side device allocates, to the target device (the backscatter communication device or the ultra-low power device), the target resource that may be used to report the second information, or the target device may actively select, based on the preset resource set configured by the network side device, the target resource used to report the second information. In this way, the target device may actively and quickly report the second information based on the target resource without waiting for an inventory of the network side device. Therefore, efficiency of reporting related information to the network side device by the target device can be improved.

The resource allocation apparatus 1000 and the information reporting apparatus 1100 in the embodiments of this application may be an electronic device, for example, an electronic device with an operating system, or may be a component in the electronic device, for example, an integrated circuit or a chip. The electronic device may be a network side device.

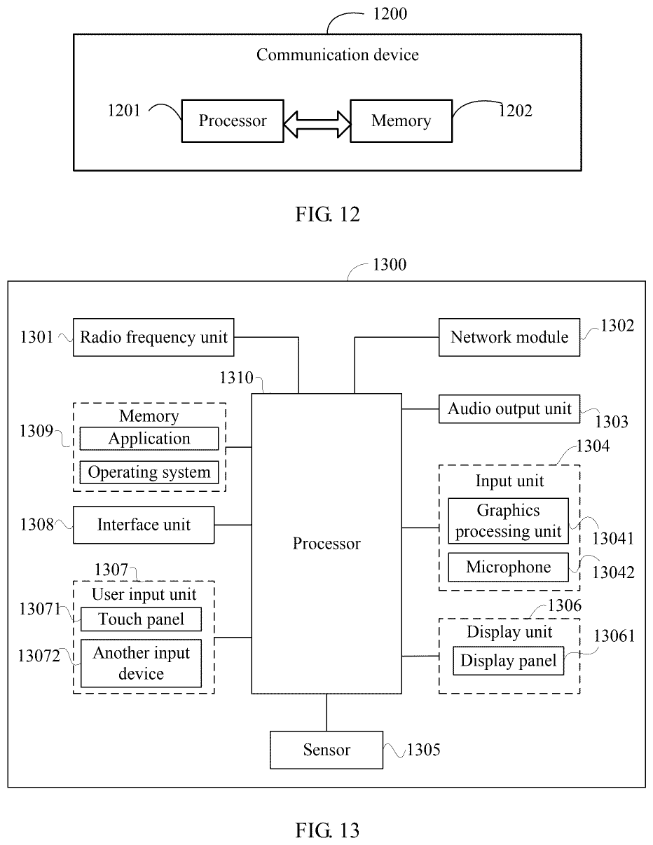

Optionally, as shown in FIG. 12, an embodiment of this application further provides a communication device 1200, including a processor 1201 and a memory 1202, and the memory 1202 stores a program or an instruction that is executable on the processor 1201. For example, in a case that the communication device 1200 is a network side device, when the program or the instruction is executed by the processor 1201, the steps of the foregoing embodiment of the resource allocation method shown in FIG. 3 are implemented, and a same technical effect can be achieved. In a case that the communication device 1200 is a target device (such as a tag), when the program or instruction is executed by the processor 1201, the steps of the foregoing embodiment of the information reporting method shown in FIG. 9 are implemented, and a same technical effect can be achieved.

An embodiment of this application further provides a network side device. The network side device is configured to implement the steps of the embodiment of the resource allocation method corresponding to FIG. 3.

An embodiment of this application further provides a reader. The reader is configured to implement the steps of the embodiment of the resource allocation method corresponding to FIG. 3.

An embodiment of this application further provides a terminal device. The terminal device is configured to implement the steps of the embodiment of the information reporting method corresponding to FIG. 9.

An embodiment of this application further provides a tag. The tag is configured to implement the steps of the embodiment of the information reporting method corresponding to FIG. 9.

An embodiment of this application further provides a network side device, including a communication interface. The communication interface is configured to send first information to a target device, where the target device includes at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device.

An embodiment of this application further provides a reader, including a communication interface. The communication interface is configured to send first information to a target device, where the target device includes at least one of a backscatter communication device and an ultra-low power device, the ultra-low power device is a terminal device whose power consumption is less than a preset threshold, the first information is used to allocate a target resource to the target device, the target resource is selected by the reader from a preset resource set according to a preset rule, or the first information is used to configure the preset resource set for the target device, so that the target device selects the target resource from the preset resource set according to the preset rule, and the target resource is used by the target device to report second information to the reader.

An embodiment of this application further provides a terminal device, including a communication interface. The communication interface is configured to receive first information from a network side device; and report second information to the network side device based on a target resource, where the first information is used to allocate the target resource to the terminal device, the target resource is selected by the network side device from a preset resource set according to a preset rule, or the first information is used to configure the preset resource set for the terminal device, so that the terminal device selects the target resource from the preset resource set according to the preset rule.

An embodiment of this application further provides a tag, including a communication interface. The communication interface is configured to receive first information from a network side device; and report second information to the network side device based on a target resource, where the first information is used to allocate the target resource to the tag, the target resource is selected by the network side device from a preset resource set according to a preset rule, or the first information is used to configure the preset resource set for the tag, so that the tag selects the target resource from the preset resource set according to the preset rule.

An embodiment of this application further provides a terminal, including a processor and a communication interface. The processor is configured to determine at least one resource, where a time domain resource corresponding to the at least one resource is continuous. The communication interface is configured to transmit a first signal on the at least one resource. The terminal embodiment corresponds to the terminal side method embodiment, each implementation process and implementation of the method embodiment can be applied to the terminal embodiment, and a same technical effect can be achieved. Specifically, FIG. 13 is a schematic diagram of a hardware structure of a terminal according to an embodiment of this application.

The terminal 1300 includes but is not limited to at least a part of components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

A person skilled in the art can understand that the terminal 1300 may further include a power supply (such as a battery) that supplies power to each component. The power supply may be logically connected to the processor 1310 by using a power supply management system, to implement functions such as charging and discharging management, and power consumption management by using the power supply management system. The terminal structure shown in FIG. 13 constitutes no limitation on the terminal, and the terminal may include more or fewer components than those shown in the figure, or combine some components, or have different component arrangements. Details are not described herein.

It should be understood that in this embodiment of this application, the input unit 1304 may include a graphics processing unit (Graphics Processing Unit, GPU) 13041 and a microphone 13042. The GPU 13041 processes image data of a static picture or a video obtained by an image capture apparatus (for example, a camera) in a video capture mode or an image capture mode. The display unit 1306 may include a display panel 13061, and the display panel 13061 may be configured in a form of a liquid crystal display, an organic light-emitting diode, or the like. The user input unit 1307 includes at least one of a touch panel 13071 and another input device 13072. The touch panel 13071 is also referred to as a touchscreen. The touch panel 13071 may include two parts: a touch detection apparatus and a touch controller. The another input device 13072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1301 may transmit the downlink data to the processor 1310 for processing. In addition, the radio frequency unit 1301 may send uplink data to the network side device. Generally, the radio frequency unit 1301 includes but is not limited to an antenna, an amplifier, a transceiver, a coupler, a low noise amplifier, a duplexer, and the like.

The memory 1309 may be configured to store a software program or an instruction and various data. The memory 1309 may mainly include a first storage area for storing a program or an instruction and a second storage area for storing data. The first storage area may store an operating system, and an application or an instruction required by at least one function (for example, a sound playing function or an image playing function). In addition, the memory 1309 may be a volatile memory or a non-volatile memory, or the memory 1309 may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1309 in this embodiment of this application includes but is not limited to these memories and any memory of another proper type.

The processor 1310 may include one or more processing units. Optionally, an application processor and a modem processor are integrated into the processor 1310. The application processor mainly processes an operating system, a user interface, an application, or the like. The modem processor mainly processes a wireless communication signal, for example, a baseband processor. It may be understood that, alternatively, the modem processor may not be integrated into the processor 1310.

The radio frequency unit 1301 is configured to receive first information from a network side device; and report second information to the network side device based on a target resource, where the first information is used to allocate the target resource to the terminal, the target resource is selected by the network side device from a preset resource set according to a preset rule, or the first information is used to configure the preset resource set for the terminal, so that the terminal selects the target resource from the preset resource set according to the preset rule.

Because the terminal may actively and quickly report the second information based on the target resource without waiting for an inventory of the network side device. Therefore, efficiency of obtaining related information of the target device can be improved.

An embodiment of this application further provides a network side device, including a communication interface. The communication interface is configured to send first information to a target device, where the target device includes at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device.

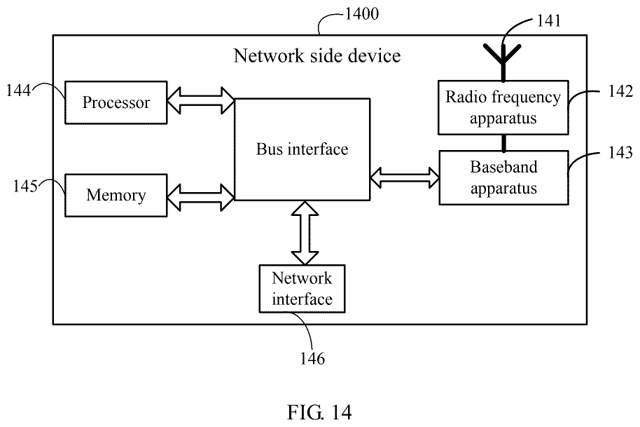

Specifically, an embodiment of this application further provides a network side device. As shown in FIG. 14, the network side device 1400 includes an antenna 141, a radio frequency apparatus 142, a baseband apparatus 143, a processor 144, and a memory 145. The antenna 141 is connected to the radio frequency apparatus 142. In an uplink direction, the radio frequency apparatus 142 receives information through the antenna 141, and sends the received information to the baseband apparatus 143 for processing. In a downlink direction, the baseband apparatus 143 processes information that needs to be sent, and sends processed information to the radio frequency apparatus 142. The radio frequency apparatus 142 processes the received information, and sends processed information through the antenna 141.

In the foregoing embodiment, the method performed by the network side device may be implemented in the baseband apparatus 143. The baseband apparatus 143 includes a baseband processor.

For example, the baseband apparatus 143 may include at least one baseband board. A plurality of chips are disposed on the baseband board. As shown in FIG. 14, one chip is, for example, a baseband processor, and is connected to the memory 145 by using a bus interface, to invoke a program in the memory 145 to perform the operations of the network side device shown in the foregoing method embodiment.

The network side device may further include a network interface 146, and the interface is, for example, a common public radio interface (common public radio interface, CPRI).

Specifically, the network side device 1400 in this embodiment of this application further includes an instruction or a program that is stored in the memory 145 and that is executable on the processor 144. The processor 144 invokes the instruction or the program in the memory 145 to perform the method shown in FIG. 9, and a same technical effect is achieved. To avoid repetition, details are not described herein.

An embodiment of this application further provides a readable storage medium. The readable storage medium stores a program or an instruction, and when the program or the instruction is executed by a processor, the processes of the foregoing embodiment of the resource allocation method or the information reporting method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the resource allocation method or the information reporting method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a non-volatile storage medium, and the computer program/program product is executed by at least one processor to implement the processes of the foregoing embodiment of the resource allocation method or the information reporting method, and a same technical effect can be achieved. To avoid repetition, details are not described herein again.

An embodiment of this application further provides a communication system, including a network side device and a target device. The network side device may be configured to perform the steps of the resource allocation method shown in FIG. 3, and the target device may be configured to perform the steps of the information reporting method shown in FIG. 9.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network side device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A resource allocation method, wherein the method comprises:
sending, by a network side device, first information to a target device, wherein
the target device comprises at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device; and the preset rule comprises at least one of the following:
selecting different resources for different reporting service types;
selecting different resources for different types of target devices;
selecting a same resource for multiple target devices;
selecting a specified resource for a specified target device; and
selecting different resources in frequency domain at different moments for a specified target device.

2. The method according to claim 1, wherein the first information is used to allocate the target resource to the target device, and before the sending, by a network side device, first information to a target device, the method further comprises:
sending, by the network side device, configuration information to the target device, wherein the configuration information is used to configure the preset resource set for the target device; and
selecting, by the network side device, the target resource from the preset resource set according to the preset rule.

3. The method according to claim 1, wherein the preset rule is determined in at least one of the following manners:
predefined in a protocol;
preconfigured by the network side device; and
indicated by the network side device.

4. The method according to claim 1, wherein the preset rule comprises selecting the different resources for the different reporting service types, and the selecting the different resources for the different reporting service types comprises:
determining, based on a quantity of target devices for the different reporting service types, to allocate at least one of a periodicity and a quantity of the target resources to the target device.

5. The method according to claim 4, wherein the reporting service type comprises urgent reporting and non-urgent reporting, and the selecting different resources for target devices for the different reporting service types further comprises:
a quantity of target resources selected for a target device for the urgent reporting is greater than a quantity of target resources selected for a target device for the non-urgent reporting.

6. The method according to claim 1, wherein the preset rule comprises selecting the different resources for the different types of target devices, and a type of the target device is determined in a preset classification manner; and
the preset classification manner comprises at least one of the following:
classifying the type of the target device based on an ID of the target device;
classifying the type of the target device based on a group to which the target device belongs;
classifying the type of the target device based on whether the target device has power;
classifying the type of the target device based on a maximum data amount that the target device is able to report; and
classifying the type of the target device based on an environment monitoring capability of the target device.

7. The method according to claim 6, wherein the preset classification manner comprises classifying the type of the target device based on the ID of the target device, and the classifying the type of the target device based on the ID of the target device comprises:
classifying a target device with an odd ID into one type, and classifying a target device with an even ID into another type; and
the selecting the different resources for the different types of target devices comprises:
selecting a first target resource for the target device with the odd ID, and selecting a second target resource for the target device with the even ID, wherein the first target resource is different from the second target resource.

8. The method according to claim 6, wherein the preset classification manner comprises classifying the type of the target device based on the ID of the target device, and the classifying the type of the target device based on the ID of the target device comprises:
classifying target devices with different IDs into different types of target devices; and
the selecting the different resources for the different types of target devices comprises:
mapping resources with different IDs to target devices with different IDs, wherein an ID of a resource is determined based on a time domain order or a frequency domain order of the resource.

9. The method according to claim 6, wherein the preset classification manner comprises classifying the type of the target device based on the group to which the target device belongs, and the classifying the type of the target device based on the group to which the target device belongs comprises:
determining, based on a data amount of the second information to be reported by the target device, the group to which the target device belongs; and
classifying target devices belonging to different groups into different types.

10. The method according to claim 6, wherein the preset classification manner comprises classifying the type of the target device based on whether the target device has the power, and the classifying the type of the target device based on whether the target device has the power comprises:
classifying a passive target device into a first type;
classifying a semi-passive target device into a second type; and
classifying an active target device into a third type.

11. The method according to claim 6, wherein the preset classification manner comprises classifying the type of the target device based on the maximum data amount that the target device is able to report, and the classifying the type of the target device based on the maximum data amount that the target device is able to report comprises:
classifying a target device that is able to report a maximum data amount less than a first data amount into a first type;
classifying a target device that is able to report a maximum data amount less than a second data amount and greater than or equal to the first data amount into a second type; and
classifying a target device that is able to report a maximum data amount less than a third data amount and greater than or equal to the second data amount into a third type; or
classifying a target device that is able to report a maximum data amount less than or equal to a first data amount into a first type;
classifying a target device that is able to report a maximum data amount less than or equal to a second data amount and greater than the first data amount into a second type; and
classifying a target device that is able to report a maximum data amount less than or equal to a third data amount and greater than the second data amount into a third type.

12. The method according to claim 6, wherein the preset classification manner comprises classifying the type of the target device based on the environment monitoring capability of the target device, and the classifying the type of the target device based on the environment monitoring capability of the target device comprises:
classifying target devices with different environment monitoring capabilities into different types.

13. The method according to claim 1, wherein the preset rule comprises selecting the same resource for the multiple target devices, and the selecting the same resource for the multiple target devices comprises:
selecting a same resource for multiple target devices of a same type.

14. The method according to claim 13, wherein
the multiple target devices of the same type comprise multiple target devices with equal or approximately equal distances from the network side device; and/or
the multiple target devices of the same type comprise multiple target devices whose locations are the same or close.

15. The method according to claim 1, wherein the preset rule comprises selecting the specified resource for the specified target device.

16. The method according to claim 1, wherein the preset rule comprises selecting the different resources in frequency domain at the different moments for the specified target device.

17. The method according to claim 15, wherein the specified target device comprises at least one of the following:
a target device for a specified purpose;
a target device of a specified type; and
at least one specified target device.

18. The method according to claim 1, wherein
the second information comprises at least one of a reporting request and information to be reported.

19. An information reporting method, wherein the method comprises:
receiving, by a target device, first information from a network side device, wherein the target device comprises one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule; and
reporting, by the target device, second information to the network side device based on the target resource, wherein
the preset rule comprises at least one of the following:
selecting different resources for different reporting service types;
selecting different resources for different types of target devices;
selecting a same resource for multiple target devices;
selecting a specified resource for a specified target device; and
selecting different resources in frequency domain at different moments for a specified target device.

20. A network side device, comprising a processor and a memory, wherein the memory stores a program or an instruction that is executable on the processor, and when the program or the instruction is executed by the processor, a resource allocation method is implemented, the method comprising:
sending, by a network side device, first information to a target device, wherein
the target device comprises at least one of a backscatter communication device and an ultra-low power device, the ultra-low power device is a terminal device whose power consumption is less than a preset threshold, the first information is used to allocate a target resource to the target device, the target resource is selected by the network side device from a preset resource set according to a preset rule, or the first information is used to configure the preset resource set for the target device, so that the target device selects the target resource from the preset resource set according to the preset rule, and the target resource is used by the target device to report second information to the network side device; and the preset rule comprises at least one of the following:
selecting different resources for different reporting service types;
selecting different resources for different types of target devices;
selecting a same resource for multiple target devices;
selecting a specified resource for a specified target device; and
selecting different resources in frequency domain at different moments for a specified target device.
